(19) United States
(12) Patent Application Publication
(10) Pub. No.: US 2025/0233954 A1
(43) Pub. Date: Jul. 17, 2025

(54) IMAGE READING DEVICE AND IMAGE READING METHOD

(71) Applicant: SEIKO EPSON CORPORATION, Tokyo (JP)

(72) Inventor: Yuji TAKASE, KITAKYUSHU-SHI (JP)

(21) Appl. No.: 19/017,948

(22) Filed: Jan. 13, 2025

(30) Foreign Application Priority Data
Jan. 15, 2024 (JP) 2024-003672

(51) Int. Cl. H04N 1/00

(52) U.S. Cl. CPC H04N 1/00824; H04N 1/00029; H04N 1/00076; H04N 1/00854; H04N 1/00862; H04N 2201/0094

(57) ABSTRACT

An image reading device including a reading unit, a display unit, and a control unit, wherein the control unit, when an external storage capable of storing image data is mounted, executes a first switching processing of switching a displayed screen to a reading executable screen on which reading of image data (stored in the external storage) can be executed. Then, when the external storage is inserted into the device, the screen is automatically switched to a job executable screen, thus, the user himself/herself can save trouble of switching the screen by an operation, and convenience is increased.

The present application is based on, and claims priority from JP Application Serial Number 2024-003672, filed Jan. 15, 2024, the disclosure of which is hereby incorporated by reference herein in its entirety.

### BACKGROUND

### 1. Technical Field

The present disclosure relates to an image reading device that reads an image of a medium and an image reading method.

### 2. Related Art

In the related art, an image reading device disclosed in JP 2016-82353 A has been known, as an image reading device to which an external storage such as a USB memory can be mounted. When a USB memory is mounted, and an operation related to the USB memory is performed, the image reading device displays a related screen.

In the existing device, although the related screen is displayed during the operation when the USB memory is mounted, an operator had to start an operation from an initial screen and reach a target operation screen.

### SUMMARY

The present disclosure is an image reading device including a reading unit configured to read an image of a medium, a display unit configured to display a plurality of screens, and a control unit, wherein the control unit is configured to execute a first switching processing of switching a displayed screen to a reading executable screen on which reading of an image of a medium is executable, when an external storage configured to store image data is mounted.

Additionally, the present disclosure is an image reading method configured to display a plurality of screens and to read an image of a medium, wherein a configuration is adopted in which when an external storage configured to store image data is mounted, a displayed screen is switched to a reading executable screen on which reading of an image of a medium is executable.

### BRIEF DESCRIPTION OF THE DRAWINGS

FIG. 1 is a block diagram illustrating a schematic configuration of an image reading device according to an embodiment of the present disclosure.

FIG. 2 is a flowchart of a USB memory mounting check executed by a control unit of the image reading device.

FIG. 3 is a first flowchart executed by the image reading device.

FIG. 4 is a second flowchart executed by the image reading device.

FIG. 5 is a diagram illustrating a transition example of a display screen.

FIG. 6 is a diagram illustrating an example of a confirmation screen.

FIG. 7 is a diagram illustrating an example of a network connection diagnosis report.

FIG. 8 is a diagram illustrating an example of a confirmation screen.

FIG. 9 is a diagram illustrating a flow of processing when an administrator has logged in.

FIG. 10 is a diagram illustrating an example of an error notification screen.

FIG. 11 is a diagram illustrating a transition example of a screen during authentication.

### DESCRIPTION OF EMBODIMENTS

Embodiments of the present disclosure will be described below with reference to the accompanying drawings.

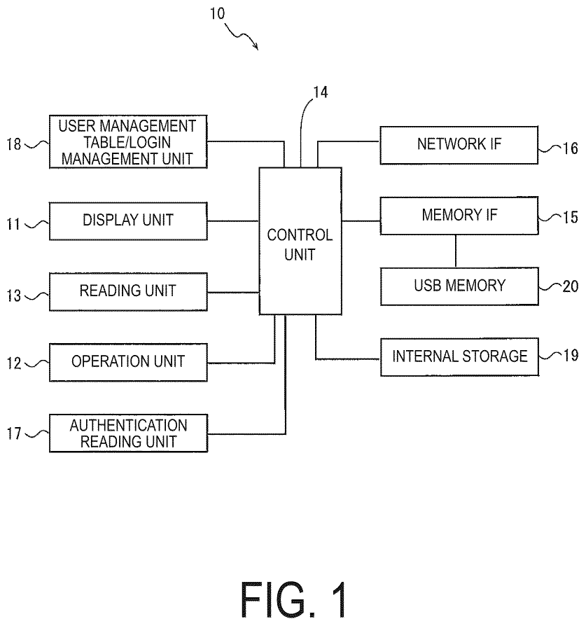

FIG. 1 illustrates an image reading device according to an embodiment of the present disclosure by a block diagram. In the drawing, an image reading device 10 includes a display unit 11 that executes various types of display for a user, an operation unit 12 through which the user inputs an operation, a reading unit 13 that reads an image of a medium, and a control unit 14 that executes control of display by the display unit 11, input of an operation by the operation unit, reading by the reading unit 13, and the like. Additionally, a memory interface 15 for USB-coupling a USB memory 20 serving as an external storage, a network interface 16 for network connection, an authentication reading unit 17 for authenticating a user using a card key or the like, a user management table/login management unit 18 for managing the user who logs in, an internal storage 19, and the like are coupled to the control unit 14, and the control unit 14 executes a control program to control these units.

The image reading device 10 includes, as basic functions, a function of executing predetermined display at the display unit 11, a function of receiving a user operation at the operation unit 12, a function of reading an image of a medium at the reading unit 13 to generate image data, and a function of transmitting the image data via the network interface 16. In addition to the function of transmitting image data, the image reading device 10 also includes a function of storing the image data in the internal storage 19, or in a USB memory 20 mounted via the memory interface.

In addition to this, the image reading device 10 includes the user management table/login management unit 18, and is capable of recording presence or absence of authentication and presence or absence of an administrator in addition to a user code and a password, and is capable of distinguishing an authenticated user, an administrator, other users, and the like, for limiting available functions. In addition, a system in which authentication is executed by making an inquiry to a server can also be used, and when an inquiry is made to the server and a result of authentication is OK, authentication information may be acquired from the server and temporarily stored in the user management table.

In the embodiment, the following processing is executed for distinguishing users.
An authenticated user can use an external storage saving function.
An administrator can use the external storage saving function, and execute a network diagnosis. Note that the external storage saving function is displayed to a user as a ScanToUSB drive function.

The control unit 14 executes various control programs and checks whether the USB memory 20 is mounted or not via the memory interface.

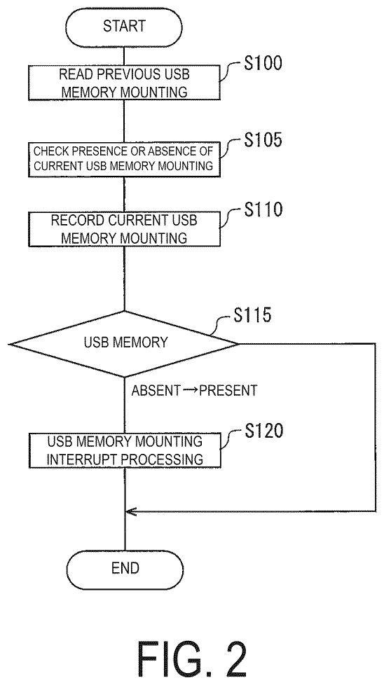

FIG. 2 is a flowchart of the USB memory mounting check executed by the control unit of the image reading device.

The control unit 14 reads previous USB memory mounting in step S100, checks whether the USB memory is currently mounted or not in step S105, and records the current USB memory mounting in step S110. In step S115, based on the recorded information, it can be determined whether the USB memory has changed from “absent” to “present” by the current check. This detects a time at which the USB memory 20, which is the external storage, is mounted. Since the USB device is mounted, the control unit 14 executes, in step S120, a USB memory-mounting interrupt processing.

It is not possible to check that the USB memory 20 was mounted only by determining whether the USB memory 20 is currently mounted or not. It is necessary to check a change from a state in which the USB memory 20 is not mounted to a state in which the USB memory 20 is mounted. For this reason, when the check is executed, a state of the last check is read (step S100), a current state is checked (step S105), and a difference between both the states (the change from absent to present) is determined. In addition, it is also necessary to record the current state as the “state of the last check” (step S110).

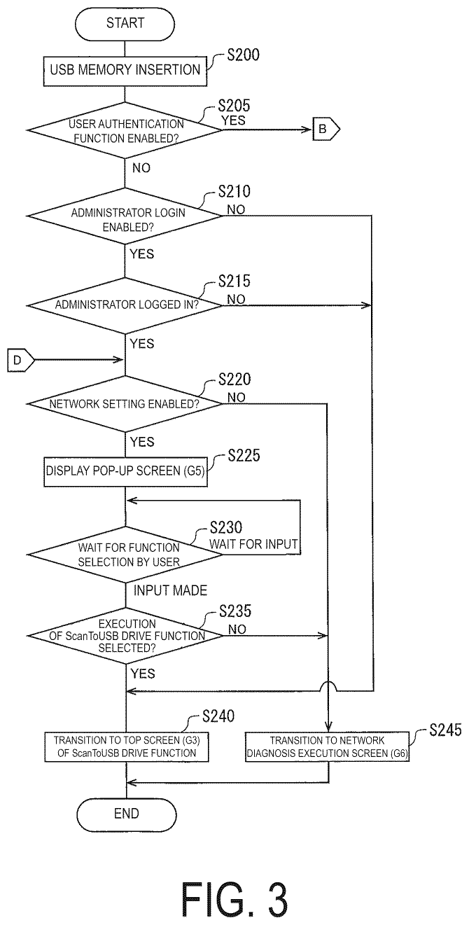

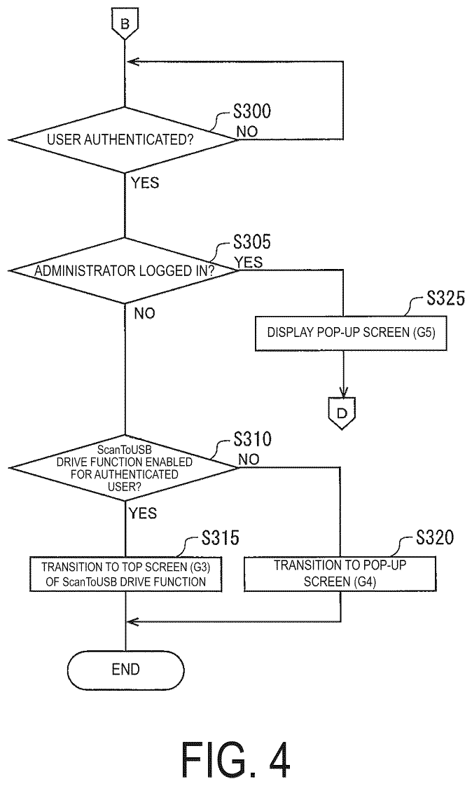

FIG. 3 is a first flowchart executed by the control unit of the image reading device, and FIG. 4 is a second flowchart executed by the image reading device.

Step S200 is a processing for detecting mounting of the USB memory 20 and corresponds to the processing illustrated in FIG. 2. When the USB memory 20 is mounted, the control unit 14 determines whether an authentication function is enabled or not in step S205. The authentication function enables limitation of functions with respect to a user or the like, using a card key or the like, and when the authentication function is enabled, the processing proceeds to the flowchart illustrated in FIG. 4.

In step S300, the control unit 14 determines whether authentication is completed or not. A user normally holds an authentication card key over the authentication reading unit 17 or the like to log in as an authenticated user, and then mounts the USB memory 20. When the USB memory 20 is mounted, there is a high possibility that the authenticated user intends the external storage saving function to be executed. For this reason, when authentication has not been completed, step S300 is repeated to wait for authentication to be made.

When the authenticated has been completed, the control unit 14 determines whether the login is made by an administrator or not in step S305. When the login is not made by an administrator, the control unit 14 determines, in step S310, whether the ScanToUSB drive function for the authenticated user is enabled or not. The ScanToUSB drive function is a function permitted only to a specific user, and whether to permit the function or not may be registered for each user with the user management table/login management unit 18, or setting may be made to permit the function when authentication has been completed. In the former case, it is sufficient that presence or absence of permission is determined by referring to a table or the like, and in the latter case, it is sufficient that presence or absence of permission is determined depending on whether authentication has been completed or not.

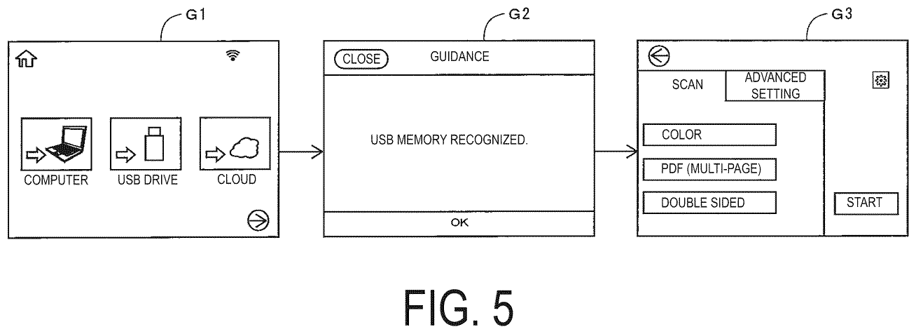

When it is determined that the ScanToUSB drive function is enabled, the control unit 14 transitions to a TOP screen (G3) of the ScanToUSB drive function as illustrated in FIG. 5 in step S315.

FIG. 5 is a diagram illustrating a transition example of a display screen.

When the USB memory 20 is not mounted, the control unit 14 displays a screen G1 at the display unit 11. The display unit 11 displays a “COMPUTER” icon, a “USB DRIVE” icon, and a “CLOUD” icon from which a storage destination is selected on a touch-operable screen. In the related art, a user needs to touch the “USB DRIVE” icon on the display unit 11 by himself/herself after mounting the USB memory 20. Since the screen itself serves as both the display unit 11 and the operation unit 12, when the “USB DRIVE” icon was touch-operated, the control unit 14 recognized that “USB DRIVE” was selected as the storage destination and displayed a screen G3.

The screen G3 to be displayed after the storage destination is determined is a screen displayed together with a “SCAN SETTING” tab, and is used for making settings about output data. The settings are contents of “SCAN SETTING”, and it is possible to select whether a reading mode is set to “COLOR” or not, to select “PDF (MULTI-PAGE)” or another format as an output format of data, and to select whether a medium to be read is “DOUBLE-SIDED” or not. These are merely examples, and other additional settings can be made. Note that the screen G3 also displays an “ADVANCED SETTING” tab, and the “ADVANCED SETTING” allows settings to be made that do not usually need to be operated so much, thereby simplifying and enriching operations.

However, in the embodiment, with mounting of the USB memory 20 being the external storage as a trigger, the control unit 14 transitions to the TOP screen (G3) of the ScanToUSB drive function through the determinations in steps S205, S300, S305, S310, and S315. In other words, when the USB memory 20 is mounted, the screen transitions to the TOP screen G3 of the ScanToUSB drive function without waiting for a user's operation. Note that since it has been recognized that the USB memory 20 being mounted, a screen G2 indicating the fact is also displayed only for a short period of time.

This corresponds to the fact that the image reading device 10 includes the reading unit 13, the display unit 11, and the control unit 14, and the control unit 14, when an external storage capable of storing image data is mounted, executes the first switching processing of switching a displayed screen to the reading executable screen on which reading of image data (stored in the external storage) can be executed.

In addition, the above also corresponds to an image reading method for, when an external storage capable of storing image data is mounted, switching a displayed screen to the reading executable screen on which reading of the image (data) (stored in the external storage) can be executed.

Then, when the external storage is inserted into the device, the screen is automatically switched to a job executable screen, thus, the user himself/herself can save trouble of switching the screen by an operation, and convenience is increased.

The reading executable screen refers to, for example, a screen on which reading settings such as “color, monochrome, gray” for a reading mode, “PDF, JPEG, TIFF, and the like” for an output format, others, single-sided/double-sided, and “an external storage such as a detachable USB/SD card, a folder, a mail, a cloud” for an output destination as a storage destination can be selected, to start reading.

In addition, the above corresponds to the fact that since the control unit 14 has transitioned to the TOP screen (G3) through the determinations in steps S205 and S300, a user authentication function is executable, and when the user authentication function is enabled, the control unit 14 executes the first switching processing after the user is authenticated by the user authentication function.

As described above, when the external storage is inserted into the device with the user authentication made, the screen is automatically switched to the job executable screen, thus, the user himself/herself can save trouble of switching the screen by an operation, and convenience is increased.

Note that the user authentication function may execute authentication by card touching, authentication by an ID and a password, authentication by a PIN code, or the like. The card touching is an operation of causing a non-contact card key to be in contact with a reading pad, and the authentication by an ID and a password and the authentication by a PIN code are operations such as inputting an ID, a password, and a PIN number by a touch pad or physical keys.

For example, reading a magnetic card by a card reader can also be used, and the case corresponds to the control unit 14 executing user authentication based on information of the magnetic card read by the card reader by the user authentication function.

With this configuration, the user authentication is executed based on the information of the magnetic card read by the card reader, thus the user authentication can be executed with a simple configuration.

The above corresponds to the fact that since the control unit 14 has transitioned to the TOP screen (G3) through the determination in step S310, the user authentication function is executable, and when the user authentication function is enabled, the control unit 14 executes the first switching processing after the user is authenticated by the user authentication function.

This corresponds to a fact that the user management table/login management unit 18 includes an external storage saving function setting function for switching between enabling and disabling the external storage saving function for saving read image data in the USB-coupled external storage, and the control unit 14 executes the first switching processing when the user is authenticated by the user authentication function in a case where the external storage saving function is set to be enabled by the external storage saving function setting function.

In this way, whether to enable or disable the external storage saving function setting can be selected. Then, since functions can be reduced by enabling a function only when necessary and disabling a function when unnecessary, operations can be simplified. In other words, a function that is not used is not displayed. Furthermore, when the USB memory 20 being the external storage is inserted into the device, the screen is automatically switched to the job executable screen, thus the user himself/herself can save trouble of switching the screen by an operation, and convenience is increased.

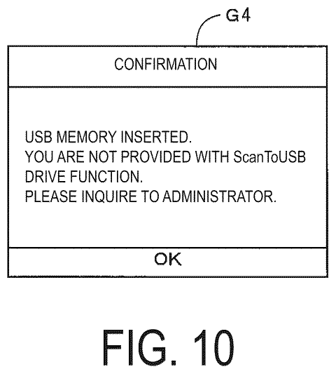

When the control unit 14 determines that the ScanToUSB drive function for the authenticated user is not enabled in step S310, the control unit 14 displays a pop-up screen G4 illustrated in FIG. 10 in step S320.

FIG. 10 is a diagram illustrating an example of an error notification screen.

The pop-up screen G4 displays “USB MEMORY INSERTED. YOU ARE NOT PROVIDED WITH ScanToUSB DRIVE FUNCTION. PLEASE INQUIRE TO ADMINISTRATOR”.

This corresponds to a fact that the control unit 14 executes a second switching processing of switching to the error screen indicating that there is no external storage saving function when the user is authenticated in a case where the user authentication function is enabled and the external storage saving function is disabled.

In this way, since the screen can be switched to the error screen indicating that there is no ScanToUSB drive function, the user can quickly and reliably know the abnormality before performing a scan operation.

Note that in step S305, although it is determined whether the login is performed by an administrator or not, with respect to the display of the error screen, such administrator setting may be present or absent, and for example, it may be determined to be present by default.

Incidentally, although a general authenticated user uses the USB memory 20 as a storage destination of image data, in the case of the image reading device 10 connected to a network, when a problem occurs in the network connection, an administrator often wants a network diagnosis result and wants to store the network diagnosis result in the USB memory 20.

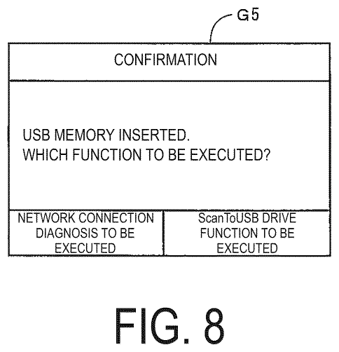

In the embodiment, when it is determined in step S305 that the login is made by an administrator, the control unit 14 displays a pop-up screen G5 illustrated in FIG. 8 in step S325.

FIG. 8 is a diagram illustrating an example of a confirmation screen.

The pop-up screen G5 displays a message “USB MEMORY INSERTED. WHICH FUNCTION TO BE EXECUTED?”, and further, a selection icon “NETWORK CONNECTION DIAGNOSIS TO BE EXECUTED” and a selection icon “ScanToUSB DRIVE FUNCTION TO BE EXECUTED” are displayed. When the selection icon “ScanToUSB DRIVE FUNCTION TO BE EXECUTED” is touched, the screen G3 is displayed, and when the selection icon “NETWORK CONNECTION DIAGNOSIS TO BE EXECUTED” is touched, the processing proceeds to step S220 as indicated by a connector D.

Note that more specifically, step S325 is displayed as step S225, and first, in step S220, the control unit 14 determines whether network setting is enabled or not, and when the network setting is enabled, the control unit 14 displays the pop-up screen G5, in step S225. Step S230 is a processing of waiting for a function selection by the user, and waits until an input is made. When an input is made, it is determined, in step S235, that execution of the ScanToUSB drive function is selected, and the screen transitions, in step S240, to the TOP screen G3 of the ScanToUSB drive function.

Note that when it is determined, in step S205, that the user authentication function is disabled, even when it is determined that the administrator login is enabled in step S210, and that the administrator login has been completed in step S215, the processing proceeds to step S220. Otherwise, the processing proceeds to step S240 without executing the network diagnosis.

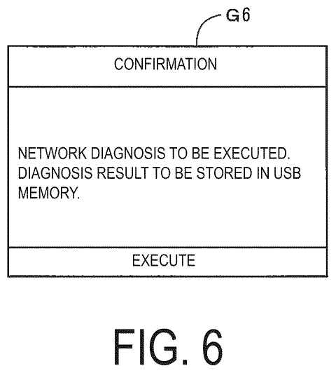

On the other hand, when the “NETWORK CONNECTION DIAGNOSIS TO BE EXECUTED” selection icon is touched, the control unit 14 displays a network diagnosis execution screen G6 on a pop-up screen illustrated in FIG. 6 in step S245.

FIG. 6 is a diagram illustrating an example of a confirmation screen.

The pop-up screen G6 displays a message “NETWORK DIAGNOSIS TO BE EXECUTED. DIAGNOSIS RESULT TO BE STORED IN USB MEMORY” and further displays a selection icon “EXECUTE”.

This corresponds to a fact that the user management table/login management unit 18 includes an administrator setting function capable of providing the user with authority as an administrator, and the control unit 14 executes a fourth switching processing of switching a displayed screen to a screen on which a network state diagnosis or the external storage saving function can be selected, when the user logs in as an administrator in an authenticated state, in a state where the user authentication function is disabled, the administrator setting function is enabled, and the network setting is enabled.

With this configuration, the screen is switched to the screen on which the network diagnosis or the ScanToUSB drive function can be selected, thus the user can freely select the network diagnosis or the ScanToUSB drive function, thereby increasing convenience.

Although the pop-up screen G5 gives the administrator the way of selection, it is also possible not to display the ScanToUSB drive function for the administrator.

In this case, the selection screen of the pop-up screen G6 may be displayed without determining whether the network setting is enabled or not.

This corresponds to a fact that the administrator setting function capable of providing the user with authority as an administrator is provided, and the control unit 14 executes the fourth switching processing of switching a displayed screen to the screen on which the network state diagnosis or the external storage saving function can be selected, when the user logs in as an administrator in the authenticated state, in a state where the user authentication function is enabled, and the administrator setting function is enabled.

With this configuration, the screen is switched to the screen on which the network diagnosis or the ScanToUSB drive function can be selected, thus the user can freely select the network diagnosis or the ScanToUSB drive function, thereby increasing convenience.

Similarly, the above corresponds to a fact that the administrator setting function that can provide the user with authority as an administrator and a network setting function for setting presence or absence of a network are provided, and the control unit 14 executes a third switching processing of switching a displayed screen to a network diagnosis execution screen on which a network state diagnosis can be executed, when the user logs in as an administrator in a state in which the user authentication function is disabled, the administrator setting function is enabled, and the network setting is disabled.

As a result, when a trouble such as failure to connect to a network occurs, information of the network can be checked, thereby improving maintainability.

Note that the administrator setting may be present or absent, and for example, it may be determined to be present by default. Further, as an example, the network includes a wired LAN, a wireless LAN, and Bluetooth connection.

Further, as illustrated in FIG. 6, a case where a network diagnosis is executed results in “DIAGNOSIS RESULT TO BE STORED IN USB MEMORY”.

This corresponds to a fact that when execution of a diagnosis is selected on the network diagnosis execution screen, the control unit 14 stores a diagnosis result in the USB memory 20 which is the external storage mounted.

With this configuration, since the diagnosis result is stored in the USB memory 20 that has been inserted into the image reading device 10, trouble of selecting a storage location is saved, and convenience is increased.

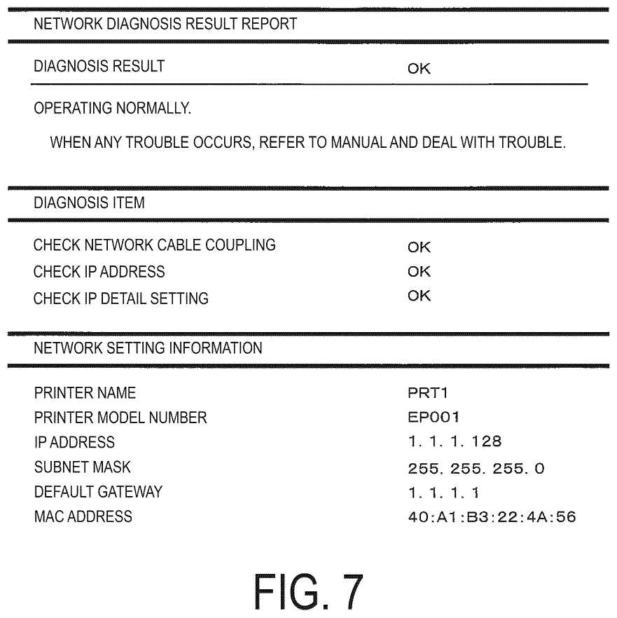

FIG. 7 is a diagram illustrating an example of a network connection diagnosis report. Contents of such a network connection diagnosis report are stored in the inserted USB memory 20.

The network connection diagnosis report illustrated in the drawing performs display as follows:
while displaying “OK” or “NG” as a diagnosis result, a simple comment “OPERATING NORMALLY. WHEN ANY TROUBLE OCCURS, REFER TO MANUAL AND DEAL WITH TROUBLE” is displayed.

Further,
“OK” or “NG” is displayed for each of “CHECK NETWORK CABLE COUPLING”, “CHECK IP ADDRESS”, and “CHECK IP DETAIL SETTING” as diagnosis items.

Finally, current network setting information is displayed as follows:
“PRINTER NAME PRT1”, “PRINTER MODEL NUMBER EP001”, “IP ADDRESS 1.1.1.128”, “SUBNET MASK 255.255.255.0”, “DEFAULT GATEWAY 1.1.1.1”, and “MAC ADDRESS 40:A1:B3:22:4A:56” are displayed.

Of course, these displays are merely examples, and can be changed as appropriate.

Next, a flow of processing when an administrator has logged in will be briefly described.

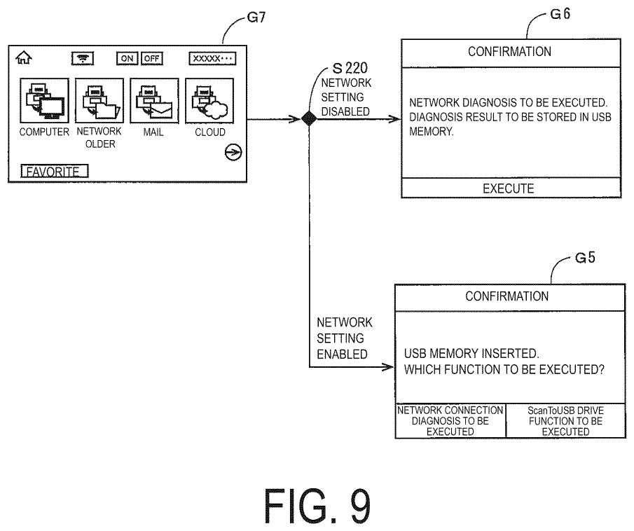

FIG. 9 is a diagram illustrating the flow of processing when an administrator has logged in.

On a top screen G7 when the administrator has logged in, “NETWORK INFORMATION” relating to a network is displayed at a top. Details of each will be omitted. Next, as storage destinations of image data, a “COMPUTER” icon, a “NETWORK FOLDER” icon, a “SEND MAIL” icon, and a “CLOUD STORAGE” icon are displayed.

Based on the determination in step S220 described above, when the network setting is disabled, the pop-up screen G6 is displayed, and when the network setting is enabled, the pop-up screen G5 is displayed.

Next, a flow of processing during authentication will be briefly described.

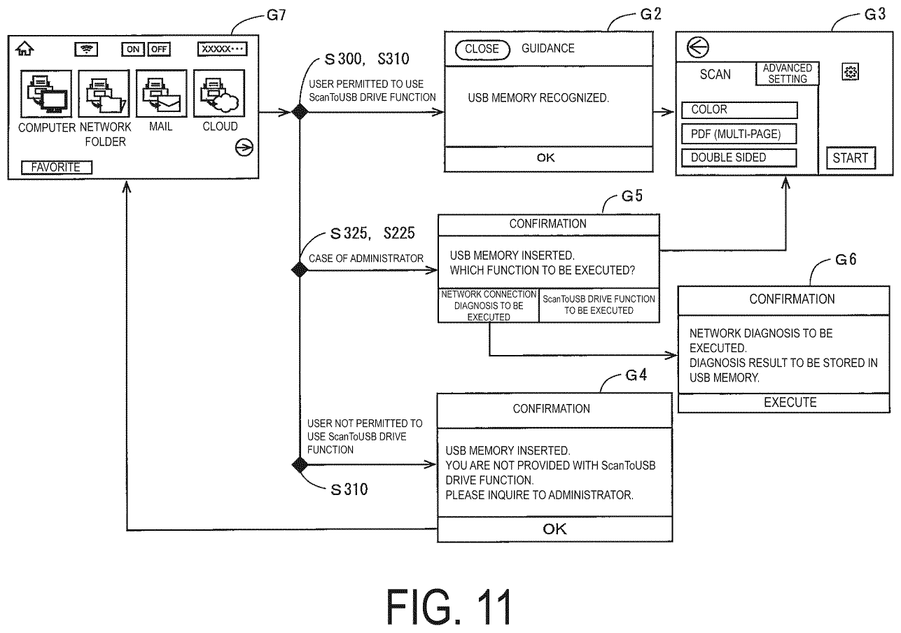

FIG. 11 is a diagram illustrating a transition example of a screen during authentication.

In a case of a user who is permitted to use the ScanToUSB drive function when the USB memory 20 is mounted in a state in which the top screen G7 is displayed, the screen transitions to the screen G2 and the screen G3, and the screen is automatically switched to the job executable screen, and thus a user himself/herself can save trouble of switching the screen by an operation, and convenience is improved.

In addition, in a case of an administrator, the screen is caused to transition to the screen G5, and is switched to the screen G3 and G6 on which the network diagnosis or the ScanToUSB drive function can be selected, so that the user can freely perform selection, thereby increasing convenience.

Further, even for the authenticated user, when it is determined that the ScanToUSB drive function is not enabled, the screen G4 is displayed. Since the screen can be switched to the error screen, the user can quickly and reliably know the abnormality before performing a scanning operation.

Note that the present disclosure is not limited to the embodiments described above. It will be obvious to those skilled in the art that
mutually replaceable members, configurations, and the like disclosed in the above embodiments can be applied by appropriately changing their combinations
although not disclosed in the embodiment, members, configurations, and the like that can be mutually replaced with the members, configurations, and the like disclosed in the above embodiments as known techniques are appropriately substituted, and also combinations thereof are changed and applied
although not disclosed in the embodiment, those skilled in the art can appropriately substitute the members and configurations and the like that can be assumed as substitutes for the members and configurations disclosed in the above embodiments based on the known techniques and the like, and also combinations thereof are changed and applied
are disclosed as embodiments of the present disclosure.

What is claimed is:

1. An image reading device, comprising:
a reading unit configured to read an image of a medium;
a display unit configured to display a plurality of screens; and a control unit, wherein
the control unit executes a first switching processing of switching a displayed screen to a reading executable screen on which reading of an image of a medium is executable, when an external storage configured to store image data is mounted.

2. The image reading device according to claim 1 configured to execute a user authentication function, wherein
the control unit executes the first switching processing, when a user is authenticated by the user authentication function, in a case where the user authentication function is enabled.

3. The image reading device according to claim 2 comprising an external storage saving function setting function configured to switch between enabling and disabling an external storage saving function for saving read image data in the external storage being USB-coupled, wherein
the control unit executes the first switching processing when the user is authenticated by the user authentication function in a case where the external storage saving function is set to be enabled by the external storage saving function setting function.

4. The image reading device according to claim 2, wherein
the control unit executes user authentication based on information of a magnetic card read by a card reader in the user authentication function.

5. The image reading device according to claim 3, wherein
the control unit executes a second switching processing of switching to an error screen indicating that the external storage saving function is unavailable when the user is authenticated in a case where the user authentication function is enabled and the external storage saving function is disabled.

6. The image reading device according to claim 3, comprising:
an administrator setting function configured to provide the user with authority as an administrator; and
a network setting function configured to set presence or absence of a network, wherein
the control unit executes a third switching processing of switching a displayed screen to a network diagnosis execution screen on which a network state diagnosis is executable, when the user logs in as an administrator in a state in which the user authentication function is disabled, the administrator setting function is enabled, and the network setting is disabled.

7. The image reading device according to claim 6, wherein
the control unit stores a diagnosis result in the mounted external storage when execution of a diagnosis is selected on the network diagnosis execution screen.

8. The image reading device according to claim 3 comprising an administrator setting function configured to provide the user with authority as an administrator, wherein
the control unit executes a fourth switching processing of switching a displayed screen to a screen on which a network state diagnosis or the external storage saving function is selectable, when the user logs in as an administrator in an authenticated state, in a state where the user authentication function is disabled, the administrator setting function is enabled, and network setting is enabled.

9. The image reading device according to claim 3 comprising an administrator setting function configured to provide the user with authority as an administrator, wherein
the control unit executes a fourth switching processing of switching a displayed screen to a screen on which a network state diagnosis or the external storage saving function is selectable, when the user logs in as an administrator in an authenticated state, in a state where the user authentication function is enabled, and the administrator setting function is enabled.

10. An image reading method configured to display a plurality of screens and to read an image of a medium, wherein
when an external storage configured to store image data is mounted, a displayed screen is switched to a reading executable screen on which reading of an image of a medium is executable.
